(19) United States
(12) Patent Application Publication
(10) Pub. No.: US 2026/0134069 A1
(43) Pub. Date: May 14, 2026

(54) Terminal access control system using graphic acceleration based on HTML5 environment

(71) Applicant: SGA Solutions Co.,Ltd., Uiwang-si (KR)

(72) Inventor: Ji Hoon JUNG, Seoul (KR)

(21) Appl. No.: 19/373,028

(22) Filed: Oct. 29, 2025

(30) Foreign Application Priority Data
Nov. 13, 2024 (KR) 10-2024-0161220

(51) Int. Cl. G06F 21/31; G06T 1/20

(52) U.S. Cl. CPC G06F 21/31; G06T 1/20

(57) ABSTRACT

A terminal access control system uses HTML5-based graphic acceleration for the secure retrieval and transmission of image data. The system detects a Remote Desktop Protocol (RDP) access attempt and identifies an acceleration target by checking if the category of retrieved information corresponds to an HTML5-transmittable image. A Graphic Acceleration Processing Unit (GPU-equipped) performs the HTML5-based acceleration process, analyzes image frames, and generates processed image information for secure transmission. A Viewing Access Control Unit then verifies the processed data against security policies received from a linked policy server. If the security policy is satisfied and the user is logged in, an Image Restoration and Output Unit performs a decryption and restoration process on the received information, outputting the final image content based on the original request.

### FIELD OF THE INVENTION

The present invention relates to a terminal access control system using graphic acceleration based on an HTML5 environment. More specifically, when a user account attempts to retrieve one of a plurality of pre-stored pieces of information, the system determines whether the information is image information capable of being accelerated in the HTML5 environment. Based on this determination, the system performs graphic acceleration processing through a GPU (Graphics Processing Unit) to generate processed image information.

Subsequently, based on policy information received from a policy server, the system determines whether the processed image information can be transmitted to the user account. If transmittable, upon completion of transmission to the user account, the system restores the processed image information into image content through a decryption and restoration process and outputs the restored content.

### BACKGROUND OF THE INVENTION

The graphic transmission market has experienced significant growth in recent years with the development of virtual reality (VR), augmented reality (AR), and artificial intelligence (AI) technologies. In particular, due to COVID-19, as non-contact work and education have increased, the demand for technologies capable of transmitting large-capacity graphic data quickly and reliably from remote locations has increased. This demand is observed not only in the fields of VR, AR, and AI technologies, but also in the Remote Desktop Protocol (RDP) field, where users remotely connect to computers to perform tasks.

However, when a user connects to another server or device via RDP, the user passes through a gateway server for authentication, and there is a problem of slower graphic transmission during this process.

In response, the industry has been developing various technologies to address these graphic transmission speed issues.

For example, Korean Registered Patent No. 10-2546633 (“Method for Transmitting a Screen of a Virtual Machine Using Hardware-Based GPU and Apparatus Using the Same”) discloses a technology for virtualizing a GPU (Graphics Processing Unit) and efficiently transmitting a screen of a virtual machine using a hardware-based GPU.

However, the above-described prior art merely discloses a technology that performs screen capture at predetermined screen capture time intervals when a screen change occurs and, when no screen change occurs, waits until a change occurs to perform video compression encoding and transmission on the captured screens. It does not disclose technology for: determining, when a user account attempts to retrieve one of a plurality of pre-stored pieces of information, whether the information is image information capable of being accelerated in an HTML5 environment; generating processed image information by performing graphic acceleration processing through a GPU based on the determination; determining, based on policy information received from a policy server, whether the processed image information can be transmitted to the user account; and, upon completion of transmission to the user account, restoring the processed image information into image content through a decryption and restoration process for output. Therefore, there exists a need for technology capable of addressing these limitations.

### SUMMARY OF THE INVENTION

The present invention was devised to address the problems of the prior art described above. When a user account attempts to retrieve one of a plurality of pre-stored pieces of information, the system determines whether the information is image information capable of being accelerated in an HTML5 environment. Based on this determination, the system performs graphic acceleration processing through a GPU (Graphics Processing Unit) to generate processed image information. Subsequently, based on policy information received from a policy server, the system determines whether the processed image information can be transmitted to the user account. Upon completion of transmission to the user account, the system restores the processed image information into image content through a decryption and restoration process for output.

By utilizing HTML5 graphic acceleration functionality to accelerate graphic processing during the authentication process when a user connects to another server or device via RDP and passes through a gateway server, and by extracting and transmitting only the differences between consecutive frames at the gateway server, the present invention aims to improve graphic quality.

In addition, without requiring separate program installation, the present invention aims to enable acceleration and playback of content including video, audio, and graphics supported in the HTML5 environment, thereby allowing the gateway server to transmit graphics in video format and provide faster transmission speeds to users.

In one embodiment, a terminal access control system using graphic acceleration based on an HTML5 environment, implemented by a computing device including one or more processors and one or more memories storing instructions executable by the processors, comprises: an acceleration target determination unit configured to determine, when detecting that a user account attempts to retrieve first information among a plurality of pre-stored pieces of information, whether the first information is first image information that becomes a target of a graphic acceleration process in an HTML5 environment; a graphic acceleration processing unit, equipped with a graphic processing device, configured to, when the acceleration target determination unit determines that the first information is the first image information, start a graphic acceleration process based on the HTML5 environment for the first image information, analyze a plurality of frames corresponding to an image based on the first image information, and generate processed image information to be transmitted to the user account; a viewing access control unit configured to, upon completion of the generation of the processed image information by the graphic acceleration processing unit, receive the processed image information from the graphic acceleration processing unit, and determine, based on policy information received from a linked policy server, whether the processed image information is viewable and transmittable to the user account; and an image restoration and output unit configured such that, when the user account is in a logged-in state and when the viewing access control unit determines that the processed image information satisfies a security policy based on the policy information and transmits the processed image information, the image restoration and output unit performs a decryption and restoration process for the received processed image information, and restores and outputs the processed image information-on which the HTML5-based graphic acceleration process has been completed-into image content based on the first image information.

Preferably, the acceleration target determination unit comprises: an information category checking unit configured to, when access based on a Remote Desktop Protocol (RDP) is detected from the user account and an attempt to retrieve the first information among the pre-stored information is detected, check a category of the first information; and an acceleration target identifying unit configured to, when the information category checking unit determines that the category of the first information corresponds to a category transmitted and received in the HTML5 environment, identify the first information as the first image information that becomes a target of the graphic acceleration process.

Preferably, the graphic acceleration processing unit comprises: a change-area analysis unit configured to, when the acceleration target determination unit determines that the first information is the first image information, start a graphic acceleration process based on the HTML5 environment for the first image information, identify each of a plurality of frames constituting an image based on the first image information, and compare a first frame with subsequent frames following the first frame to analyze whether a change area satisfying a preset change condition exists in an area of a second frame compared with an area of the first frame; and a frame grouping unit configured to, when the change-area analysis unit detects that the second frame includes a change area satisfying the preset change condition compared with the first frame, classify the first frame as a reference frame and extract only the change area from the second frame and group it with the reference frame.

Preferably, the preset change condition is a reference condition for identifying a change area by comparing a later frame with a previous frame among the plurality of frames, and is a condition value for determining whether a difference exists in grid values of a part of the overall area of the later frame compared to the overall grid of the previous frame after dividing both the previous frame and the later frame into equal-sized grids.

Optionally, the graphic acceleration processing unit further comprises: a processed-image-information generation unit configured to, upon completion of the function of the frame grouping unit, generate the processed image information based on the reference frame and the partial frames corresponding to the change areas grouped with the reference frame; and an information encryption-transmission unit configured to, upon completion of the function of the processed-image-information generation unit, encrypt the processed image information based on a preset encryption rule and transmit the processed image information to the viewing access control unit based on a preset protocol.

Optionally, the processed image information is script-configurable information, in which, when a later frame among the plurality of frames is compared with a previous frame divided into equal-sized grids and a difference occurs in grid values of a part of the overall area of the later frame compared to the previous frame, an area corresponding to the changed grid value is extracted as a change area, the previous frame is treated as a reference frame, and partial frames corresponding to the extracted change area are grouped with the reference frame.

Preferably, the viewing access control unit comprises: a policy-content checking unit configured to, when the reception of the processed image information from the graphic acceleration processing unit based on a preset protocol is completed, check detailed policy contents based on the policy information received from the linked policy server; a policy-satisfaction verification unit configured to, upon completion of the function of the policy-content checking unit, check whether attribute information of the processed image information satisfies the detailed policy contents and determine, based on the verification result, whether the processed image information can be transmitted to the user account; and a policy-satisfaction information transmission unit configured to, when the attribute information of the processed image information satisfies the detailed policy contents upon completion of the function of the policy-satisfaction verification unit, transmit the processed image information to the image restoration and output unit based on the preset protocol.

Preferably, the image restoration and output unit comprises: a key receiving unit configured to, when receiving the processed image information from the viewing access control unit, start a decryption and restoration process for the received processed image information and receive, from the graphic acceleration processing unit, a decryption key based on a preset encryption rule; a decryption completion unit configured to, upon completion of the reception of the decryption key, apply the decryption key to a pre-stored decryption algorithm to decrypt the encrypted processed image information and identify a reference frame and partial frames corresponding to change areas grouped with the reference frame based on the processed image information; and an image content restoration unit configured to, upon completion of the function of the decryption completion unit, sequentially paste the partial frames corresponding to the change areas into regions where changes occurred in the overall area of the reference frame, thereby restoring the processed image information into the first image information.

Preferably, upon completion of the function of the image content restoration unit and completion of restoration of the first image information, the image restoration and output unit outputs, through a display, image content based on the restored first image information, thereby completing graphic acceleration for the first image information in an HTML5-based RDP environment.

The terminal access control system using graphic acceleration based on an HTML5 environment addresses the problem of slower graphic transmission that occurs when a user connects to another server or device via RDP (Remote Desktop Protocol) and passes through a gateway server for authentication. The present invention accelerates graphic processing by utilizing HTML5 graphic acceleration functionality and improves graphic quality by extracting and transmitting only the differences between consecutive frames at the gateway server.

In addition, without requiring separate program installation, the present invention enables acceleration and playback of content-including video, audio, and graphics-supported in the HTML5 environment, thereby allowing the gateway server to transmit graphics in video format and provide faster transmission speeds to users.

### BRIEF DESCRIPTION OF THE DRAWINGS

FIG. 1 is a block diagram illustrating a terminal access control system using graphic acceleration based on an HTML5 environment according to an embodiment of the present invention.

FIG. 2 is a block diagram illustrating an acceleration target determination unit of the system according to an embodiment of the present invention.

FIG. 3 is a block diagram illustrating a graphic acceleration processing unit of the system according to an embodiment of the present invention.

FIG. 4 is another block diagram illustrating the graphic acceleration processing unit of the system according to an embodiment of the present invention.

FIG. 5 is a block diagram illustrating a viewing access control unit of the system according to an embodiment of the present invention.

FIG. 6 is a block diagram illustrating an image restoration and output unit of the system according to an embodiment of the present invention.

FIG. 7 is a diagram illustrating an example of an internal configuration of a computing device according to an embodiment of the present invention.

### DETAILED DESCRIPTION OF THE INVENTION

Various embodiments and/or aspects will now be disclosed with reference to the drawings. In the following description, numerous specific details are set forth to provide a thorough understanding of one or more aspects for explanatory purposes. However, those skilled in the art will recognize that these aspects may be practiced without such specific details. The following description and accompanying drawings describe specific exemplary aspects in detail. These aspects are illustrative, and various methods within the principles of the aspects may be used; the description is intended to encompass such aspects and their equivalents.

As used herein, the terms “embodiment,” “example,” “aspect,” and “illustrative” do not necessarily indicate that the described aspect or design is superior to other aspects or designs or has advantages over them.

The terms “comprises” and/or “comprising” indicate the presence of the stated features and/or components but do not exclude the presence or addition of one or more other features, components, and/or groups thereof.

Ordinal terms such as first and second may be used to describe various components but are not limited by the terms; the terms are used only to distinguish one component from another. For example, a first component may be named a second component and vice versa without departing from the scope of the invention. The term “and/or” includes any and all combinations of the associated listed items.

Unless otherwise defined, all terms used herein, including technical or scientific terms, have the same meaning as commonly understood by those of ordinary skill in the art. Terms defined in general dictionaries should be interpreted as consistent with the context of the related technology and should not be interpreted in an idealized or overly formal sense unless explicitly defined in the embodiments.

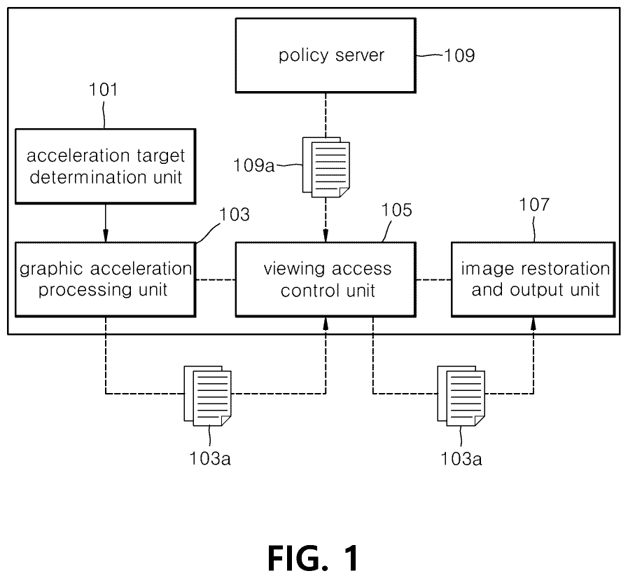

FIG. 1 is a block diagram for explaining a terminal access control system using graphic acceleration based on HTML5 environment according to an embodiment of the present invention.

Referring to FIG. 1, a terminal access control system using graphic acceleration based on HTML5 environment (100), implemented by a computing device including one or more processors and one or more memories storing instructions executable by the processors, may include an acceleration target determination unit (101), a graphic acceleration processing unit (103), a viewing access control unit (105), and an image restoration and output unit (107).

In one embodiment, the acceleration target determination unit (101) is configured to determine, when detecting that a user account attempts to retrieve first information among a plurality of pre-stored pieces of information, whether the first information is first image information that becomes a target of a graphic acceleration process in an HTML5 environment.

In one embodiment, the plurality of pre-stored pieces of information are stored in a database and may include information composed of text, images, videos, and graphics.

In one embodiment, when the user account attempts to retrieve the first information among the plurality of pre-stored pieces of information, the acceleration target determination unit (101) determines whether the first information is the first image information that becomes a target of a graphic acceleration process in the HTML5 environment.

HTML5 (HyperText Markup Language version 5) is the fifth version of HTML, a markup language used to produce web documents, and is a standard proposal that plays a dominant role in structuring web pages on the World Wide Web (WWW). While conventional HTML mainly displayed text and images, HTML5 supports playback in the web browser—without separate plug-ins—of various multimedia content such as video, audio, and graphics.

As the purpose of the present invention is to accelerate graphic processing using HTML5 graphic acceleration and to improve graphic quality by extracting and transmitting only the differences between consecutive frames at a gateway server, the acceleration target determination unit (101) determines whether the first information to be retrieved by the user account is first image information processable in the HTML5 environment.

More specifically, the acceleration target determination unit (101) may, when the user account accesses information stored in a particular device or server via the HTML5 environment, check whether that information is multimedia content supported in the HTML5 environment, including video, audio, and graphics. Although the present specification exemplifies “image information” as the information to be processed by the HTML5-based graphic acceleration process, it may also include graphic information and multimedia information.

In one embodiment, the graphic acceleration processing unit (103), which is equipped with a graphic processing device, is configured to, when the acceleration target determination unit (101) determines that the first information is the first image information, start a graphic acceleration process based on the HTML5 environment for the first image information and analyze a plurality of frames corresponding to an image based on the first image information to generate processed image information (103a) to be transmitted to the user account.

In one embodiment, the graphic acceleration processing unit (103) has a configuration that performs the graphic acceleration process for the first image information.

In one embodiment, when the first information is confirmed to be first image information (or graphic information, multimedia information) that becomes a target of the graphic acceleration process in the HTML5 environment, the graphic acceleration processing unit (103) starts the graphic acceleration process targeting the first image information.

The graphic acceleration process may include selecting a reference frame among a plurality of frames constituting an image based on the first image information, identifying frames (other than the reference frame) that include change areas in which changes occurred within the overall area of the reference frame, extracting only the change areas from the identified frames as partial frames, grouping the extracted partial frames with the reference frame, and generating the processed image information (103a).

More specifically, the graphic acceleration process may be performed on a plurality of frames constituting the image based on the first image information. For example, a previous frame and a current frame may be divided into 8×8 blocks, differences in pixel values may be calculated for each block, blocks with differences greater than or equal to a threshold may be identified as change areas, and the identified change areas may be grouped with the reference frame.

In one embodiment, the graphic acceleration processing unit (103) completes generation of the processed image information (103a) to be transmitted to the user account by completing the graphic acceleration process for the plurality of frames constituting the image based on the first image information.

In one embodiment, the viewing access control unit (105), upon completion of the generation of the processed image information (103a) by the graphic acceleration processing unit (103) and while receiving the processed image information (103a) from the graphic acceleration processing unit, determines—based on policy information (109a) received from a linked policy server (109)—whether the processed image information (103a) is information that can be transmitted to and viewed by the user account.

In one embodiment, when the viewing access control unit (105) receives the processed image information (103a) generated by the graphic acceleration processing unit (103), the viewing access control unit may receive the policy information (109a) from the linked policy server (109) before transmitting the processed image information (103a) to the user account.

In one embodiment, the policy information (109a) includes detailed policy contents to ensure the confidentiality, integrity, and availability of the first image information that is the source of the processed image information (103a) and to protect the information from external threats. For example, the detailed policy contents may include whether encryption is required, whether decryption on the user account side is enabled, communication protocol, compatible devices, whether installation of compatible programs is required, the versions of compatible programs, and whether compatible programs are updated.

In one embodiment, the viewing access control unit (105) compares the detailed policy contents based on the policy information (109a) with attribute information included in the processed image information (103a) and checks whether the processed image information (103a) satisfies the security policies to be provided to the user account.

Accordingly, when the processed image information (103a) is confirmed to be information that can be transmitted to and viewed by the user account, the viewing access control unit (105) may transmit the processed image information (103a) to the user account based on a preset protocol (preset by an administrator or based on a security policy).

In one embodiment, the image restoration and output unit (107) is configured such that, when the user account is in a logged-in state and when the viewing access control unit (105), based on the policy information (109a), determines that the processed image information (103a) satisfies a security policy and transmits the processed image information (103a), the image restoration and output unit performs a decryption and restoration process for the received processed image information (103a) and restores and outputs the processed image information (103a)—on which the HTML5-based graphic acceleration process has been completed—into image content based on the first image information.

In one embodiment, upon receiving the processed image information (103a) from the viewing access control unit (105), the image restoration and output unit (107) performs the decryption and restoration process for the received processed image information (103a).

In one embodiment, the decryption and restoration process decrypts the processed image information (103a) that has been encrypted by the graphic acceleration processing unit (103), and then, based on the decrypted processed image information (103a), sequentially pastes partial frames corresponding to change areas grouped with a reference frame into the reference frame to restore image content (or graphic content, multimedia content) based on the first image information.

In one embodiment, by completing the decryption and restoration process for the processed image information (103a), the image restoration and output unit (107) restores and outputs—through a display of an electronic device in which the user account is logged in—image content based on the first image information that is the source of the processed image information (103a).

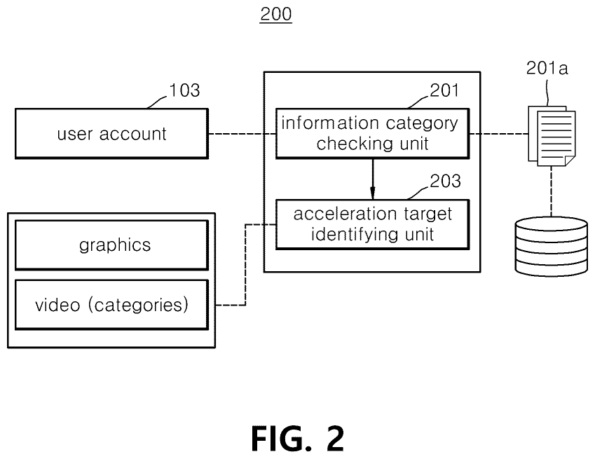

FIG. 2 is a block diagram for explaining an acceleration target determination unit according to an embodiment.

Referring to FIG. 2, the system (e.g., the system (100) of FIG. 1) may include an acceleration target determination unit (200) (e.g., the acceleration target determination unit (101) of FIG. 1).

In one embodiment, when detecting that a user account attempts to retrieve first information (201a) among a plurality of pre-stored pieces of information, the acceleration target determination unit (200) determines whether the first information (201a) is first image information that becomes a target of a graphic acceleration process in the HTML5 environment.

To perform the above function, the acceleration target determination unit (200) includes an information category checking unit (201) and an acceleration target identifying unit (203).

In one embodiment, when RDP-based access is detected from the user account and an attempt to retrieve the first information (201a) among the plurality of pre-stored pieces of information is detected, the information category checking unit (201) checks the category of the first information (201a). The information category checking unit (201) may detect an attempt to retrieve the first information (201a) from the database while RDP-based access from the user account is detected.

Accordingly, to check whether the first information (201a) is information that can be provided to the user account in the HTML5 environment, the information category checking unit (201) may check whether the category of the first information (201a) satisfies preset categories.

The preset categories constitute a criterion for checking whether a graphic acceleration process can be performed on the first information (201a) and whether the first information (201a) can be provided to the user account in the HTML5 environment, and may include a graphic category and a video category supported in the HTML5 environment for acceleration. That is, the information category checking unit (201) may check whether the category of the first information (201a) is one of the graphic categories and the video category.

In one embodiment, when the information category checking unit (201) determines that the category of the first information (201a) corresponds to a category transmitted and received in the HTML5 environment, the acceleration target identifying unit (203) identifies the first information as the first image information that becomes a target of the graphic acceleration process. When the category of the first information (201a) is confirmed to be one of the graphic categories and the video category based on the preset categories, the acceleration target identifying unit (203) completes identification of the first information (201a) as first image information that can be provided to the user account in the HTML5 environment and becomes a target of the graphic acceleration process.

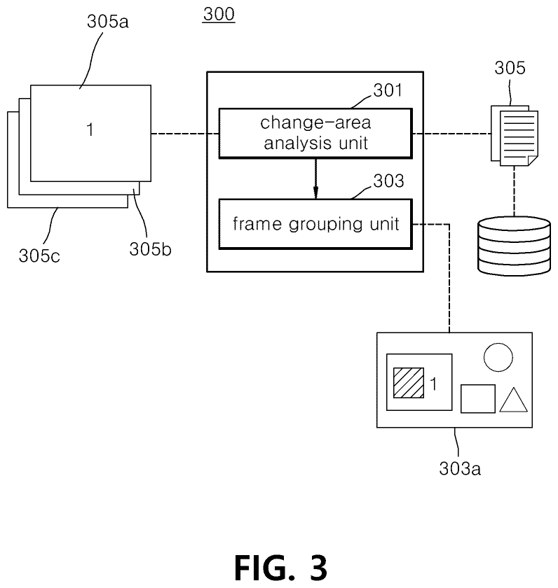

FIG. 3 is a block diagram for explaining a graphic acceleration processing unit according to an embodiment.

Referring to FIG. 3, the system (e.g., the system (100) of FIG. 1) may include a graphic acceleration processing unit (300) (e.g., the graphic acceleration processing unit (103) of FIG. 1).

In one embodiment, the graphic acceleration processing unit (300), equipped with a graphic processing device, is configured to, when the acceleration target determination function confirms the first information as first image information (305), start a graphic acceleration process based on the HTML5 environment for the first image information (305) and analyze a plurality of frames (305a, 305b, 305c) corresponding to an image based on the first image information (305) to generate processed image information (303a) to be transmitted to the user account.

To perform the above function, the graphic acceleration processing unit (300) may include a change-area analysis unit (301) and a frame grouping unit (303). The change-area analysis unit (301) starts the HTML5-based graphic acceleration process when the first information is confirmed as the first image information (305), identifies each of the plurality of frames (305a, 305b, 305c) constituting the image based on the first image information (305), and compares a first frame (305a) with subsequent frames (305b, 305c) following the first frame (305a) to analyze whether a change area exists in a region of a second frame (305b) compared with a corresponding region of the first frame (305a), the change area satisfying a preset change condition.

At this time, when a difference occurs in the pixel values of block 3 of the second frame (305b) compared to block 3 of the first frame (305a), the change-area analysis unit (301) determines that block 3 satisfies the preset change condition and identifies the region corresponding to block 3 of the second frame (305b) as a first change area. Likewise, when analyzing a third frame (305c) relative to the second frame (305b), if block 5 satisfies the preset change condition, the region corresponding to block 5 of the third frame (305c) may be identified as a second change area.

The preset change condition may be the criterion for identifying change areas by comparing a later frame with a previous frame among the plurality of frames. Both frames are divided into equal-sized grids, and the condition value determines whether differences occur in grid units of a part of the overall area of the later frame compared to the overall grid of the previous frame.

When the second frame (305b) includes a change area satisfying the preset change condition relative to the first frame (305a), the frame grouping unit (303) classifies the first frame (305a) as the reference frame and groups, with the reference frame, only the change area extracted from the second frame (305b). When the second change area is found in the third frame (305c), the frame grouping unit (303) may continue grouping the change areas with the reference frame.

In view of the purpose of accelerating transmission and output, the first frame (305a) is treated as the reference frame, a partial frame corresponding to the first change area is pasted into block 3 of the first frame (305a) to match the pixel values of the second frame (305b), and then a partial frame corresponding to the second change area is pasted into block 5; the grouping proceeds sequentially on the basis of the first frame (305a).

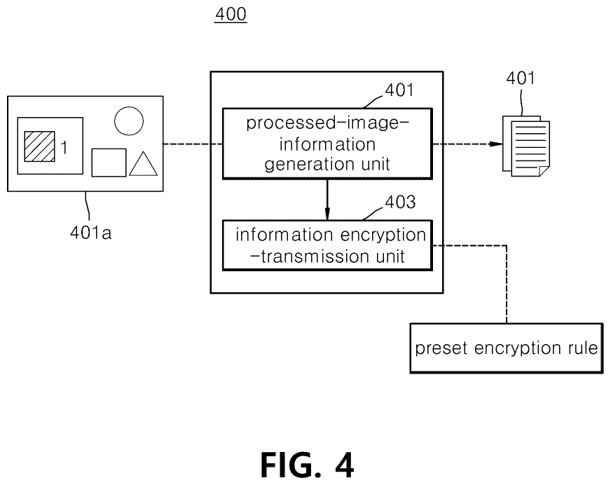

FIG. 4 is another block diagram for explaining the graphic acceleration processing unit according to an embodiment.

Referring to FIG. 4, the system may include a graphic acceleration processing unit (400) (e.g., the unit (103) of FIG. 1). The unit (400), equipped with a graphic processing device, starts a graphic acceleration process based on the HTML5 environment for the first image information when the first information is confirmed as such, and generates processed image information (401a) for transmission to the user account after analyzing the frames.

To perform this, the unit (400) may include a processed-image-information generation unit (401) and an information encryption-transmission unit (403). At this time, when generating the processed image information (401a), the processed-image-information generation unit (401) may generate attribute information together and include it as part of the processed image information (401a). The attribute information may include contents regarding security policies required for the user account to view the processed image information (e.g., a decryption-enabled setting at the user side, protocol settings, compatible device settings, compatible program installation settings, version settings, and latest update confirmation settings).

The processed image information (401a) may be information in which, when a later frame is compared with a previous frame divided into equal-sized grids and a difference occurs in grid values for a part of the overall area of the later frame compared to the previous frame, the area corresponding to the changed grid value is extracted as a change area, the previous frame is treated as the reference frame, and partial frames corresponding to the extracted change area are grouped with the reference frame. The processed image information may be constructed as a reference frame plus partial frames grouped thereto, or as script-configurable information.

Upon completion of the function of the processed-image-information generation unit (401), the information encryption-transmission unit (403) encrypts the processed image information (401a) based on a preset encryption rule—e.g., an AES (Advanced Encryption Standard) algorithm—and transmits the encrypted processed image information (401a) to the viewing access control unit (e.g., the unit (105) of FIG. 1) based on a preset protocol. The preset protocol may be one of HTTP (HyperText Transfer Protocol), HTTPS (HTTP Secure), RDP (Remote Desktop Protocol), SSH (Secure Shell), Telnet, FTP (File Transfer Protocol), and VNC (Virtual Network Computing).

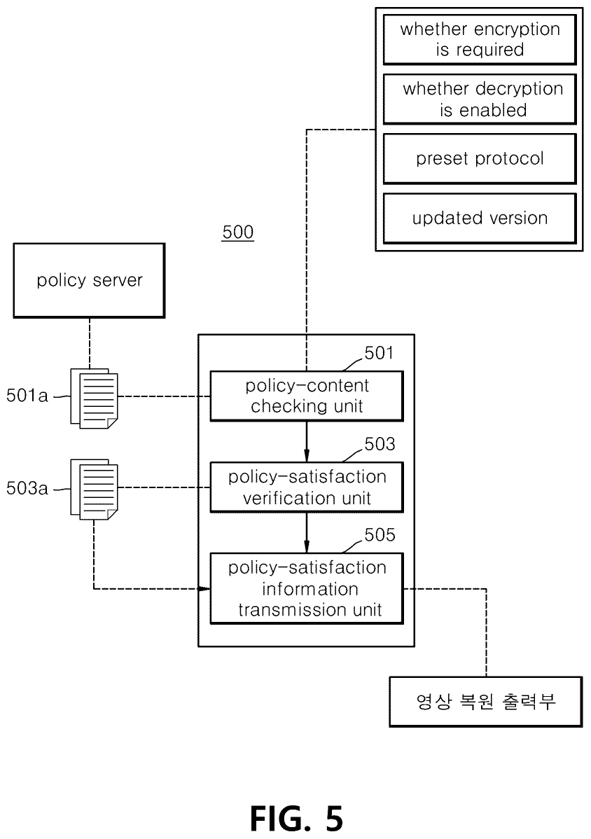

FIG. 5 is a block diagram for explaining a viewing access control unit according to an embodiment.

Referring to FIG. 5, the system (e.g., the system (100) of FIG. 1) may include a viewing access control unit (500) (e.g., the unit (105) of FIG. 1). Upon completion of the generation of the processed image information (503a) by the graphic acceleration processing unit (e.g., the unit (103) of FIG. 1) and while receiving the processed image information (503a) from the graphic acceleration processing unit, the viewing access control unit (500) determines-based on policy information (501a) received from a linked policy server-whether the processed image information (503a) can be transmitted to and viewed by the user account.

To perform this, the viewing access control unit (500) may include a policy-content checking unit (501), a policy-satisfaction verification unit (503), and a policy-satisfaction information transmission unit (505). When reception of the processed image information (503a) based on a preset protocol is completed, the policy-content checking unit (501) checks detailed policy contents based on the policy information (501a) received from the linked policy server. The detailed policy contents may include whether encryption is required, whether decryption on the user side is enabled, communication protocol, compatible devices, whether compatible program installation is required, versions of compatible programs, and whether compatible programs are updated.

Upon completion of the function of the policy-content checking unit (501), the policy-satisfaction verification unit (503) checks whether the attribute information included in the processed image information (503a) satisfies the detailed policy contents and determines, based on the result, whether the processed image information (503a) can be transmitted to the user account. The attribute information may include, as attribute items, a decryption-enabled setting at the user side, protocol settings, compatible device settings, compatible program installation settings, program version settings, and latest update confirmation settings. If the attribute items satisfy the detailed policy contents, the policy-satisfaction information transmission unit (505) transmits the processed image information (503a) to the image restoration and output unit (e.g., the unit (107) of FIG. 1) based on the preset protocol (e.g., the protocol indicated by the policy information (501a)).

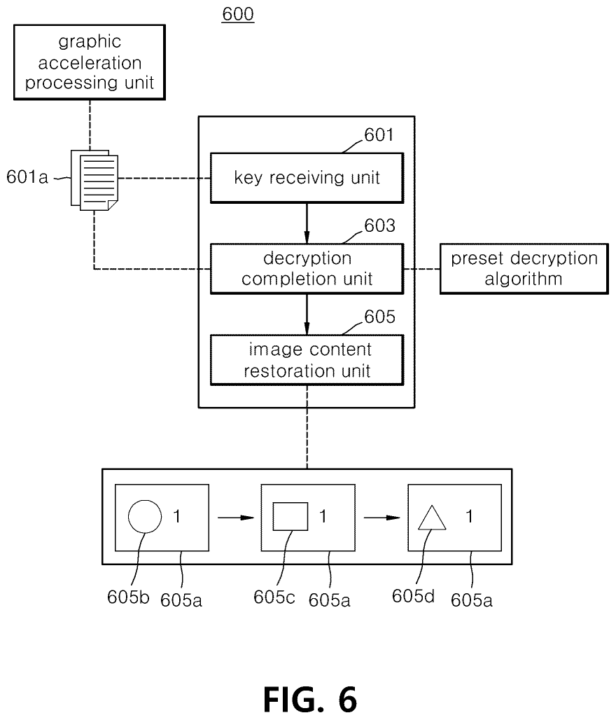

FIG. 6 is a block diagram for explaining an image restoration and output unit according to an embodiment.

Referring to FIG. 6, the system (e.g., the system (100) of FIG. 1) may include an image restoration and output unit (600) (e.g., the unit (107) of FIG. 1). The image restoration and output unit (600) is configured such that, when the user account is in a logged-in state and when the viewing access control unit (e.g., the unit (105) of FIG. 1) determines that the processed image information satisfies a security policy based on the policy information and transmits the processed image information, the image restoration and output unit performs a decryption and restoration process for the received processed image information and restores and outputs the processed image information—on which the HTML5-based graphic acceleration process has been completed—into image content based on the first image information.

To perform this, the image restoration and output unit (600) may include a key receiving unit (601), a decryption completion unit (603), and an image content restoration unit (605). When receiving the processed image information from the viewing access control unit, the key receiving unit (601) starts the decryption and restoration process for the received processed image information and receives, from the graphic acceleration processing unit, a key (601a) based on a preset encryption rule. The key (601a) may be the same as the key used by the graphic acceleration processing unit to encrypt the processed image information.

Upon completion of the reception of the key (601a), the decryption completion unit (603) applies the key (601a) to a pre-stored decryption algorithm to decrypt the encrypted processed image information and identifies a reference frame and partial frames corresponding to change areas grouped with the reference frame based on the processed image information.

Then, upon completion of the function of the decryption completion unit (603), the image content restoration unit (605) sequentially pastes the partial frames corresponding to the change areas into the regions where changes occurred in the overall area of the reference frame, thereby restoring the processed image information into the first image information. For example, the image content restoration unit (605) may paste, into block 3 of the first frame (605a), a partial frame (605b) corresponding to a first change area extracted from a second frame; then paste, into block 5, a partial frame (605c) corresponding to a second change area extracted from a third frame; and then paste, into block 1, a partial frame (605d) corresponding to a third change area extracted from a fourth frame. Although the drawings illustrate pasting into the same block regions sequentially, the block region positions into which the partial frames corresponding to the respective change areas are pasted may differ from one another.

Upon completion of the function of the image content restoration unit (605) and completion of restoration of the first image information, the image restoration and output unit (600) outputs image content based on the first image information through a display, thereby completing graphic acceleration for the first image information in the HTML5 environment of an RDP system.

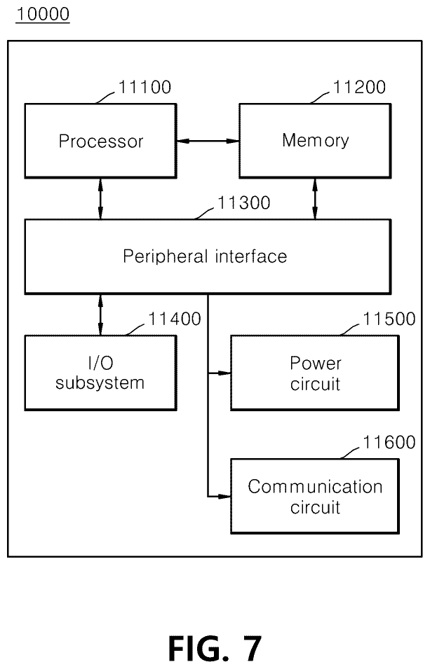

FIG. 7 illustrates an example of an internal configuration of a computing device according to an embodiment of the present invention. As shown, a computing device (10000) may include at least a processor (11100), a memory (11200), a peripheral interface (11300), an input/output (I/O) subsystem (11400), a power circuit (11500), and a communication circuit (11600). The computing device (10000) may correspond to the computing device that implements the terminal access control system described above.

The memory (11200) may include, for example, high-speed random-access memory, magnetic disks, SRAM, DRAM, ROM, flash memory, or non-volatile memory, and may store software modules, instruction sets, and various data necessary for operation of the computing device (10000). Access by other components such as the processor (11100) or the peripheral interface (11300) to the memory (11200) may be controlled by the processor (11100).

The peripheral interface (11300) may couple input and/or output peripherals of the computing device (10000) to the processor (11100) and the memory (11200). The processor (11100) executes software modules or instruction sets stored in the memory (11200) to perform various functions for the computing device (10000) and to process data.

The I/O subsystem (11400) may couple various I/O peripherals to the peripheral interface (11300). For example, the I/O subsystem (11400) may include controllers for coupling monitors, keyboards, mice, printers, touchscreens, or sensors to the peripheral interface (11300). Alternatively, I/O peripherals may be coupled directly to the peripheral interface (11300) without passing through the I/O subsystem (11400).

The power circuit (11500) supplies power to some or all components of the device and may include a power management system, one or more power sources such as a battery or AC power, a power failure detection circuit, converters or inverters, power indicators, or other components for power generation, management, and distribution.

The communication circuit (11600) enables communication with other computing devices via at least one external port and, where appropriate, may include an RF circuit to transmit and receive RF (electromagnetic) signals to enable communication.

This configuration is only an example. The computing device (10000) may omit some components shown, include additional components not shown, or combine two or more components. For example, a computing device for a mobile communication terminal may further include a touchscreen or sensors and may include, in the communication circuit (11600), circuits for RF communication using various communication methods (Wi-Fi, 3G, LTE, Bluetooth, NFC, Zigbee, etc.). The components may be implemented as hardware, software, or combinations thereof, including one or more integrated circuits specialized for signal processing or applications.

The methods according to embodiments may be implemented as program instructions executable by various computing devices and recorded on computer-readable media. The program may be a PC-based program or a mobile-terminal application. The application may be installed on a user terminal through a file distribution system, which may include a file transmission unit (not shown) configured to transmit files in response to requests from the user terminal.

The devices described above may be implemented by hardware components, software components, and/or combinations thereof. For example, the devices and components may be implemented using one or more general-purpose or special-purpose computers such as processors, controllers, ALUs, DSPs, microcomputers, FPGAs, PLUS, microprocessors, or any other devices capable of executing and responding to instructions. A processing device may run an operating system and one or more software applications running on the operating system, and in response to software execution may access, store, manipulate, process, and generate data. Although a single processing device may be described for convenience, it may include multiple processing elements and/or multiple types of processing elements (e.g., multiple processors or a processor and a controller), and other processing configurations such as parallel processors are also possible.

Software may include a computer program, code, instructions, or any combination thereof, and may configure a processing device to operate as desired or instruct the processing device independently or collectively. Software and/or data may be embodied permanently or temporarily in any type of machine, component, physical device, virtual equipment, computer storage medium, or device to be interpreted by a processing device or to provide instructions or data to a processing device. Software may be distributed across networked computing devices such that it is stored or executed in a distributed manner. Software and data may be stored on one or more computer-readable recording media.

Program instructions for carrying out the methods according to embodiments may be recorded on computer-readable media that may include program instructions, data files, data structures alone or in combination. The program instructions recorded on the media may be specially designed and configured for the embodiments or may be available to those skilled in computer software. Examples of the media include magnetic media such as hard disks, floppy disks, and magnetic tapes; optical media such as CD-ROMs and DVDs; magneto-optical media such as floptical disks; and hardware devices specially configured to store and execute program instructions such as ROM, RAM, and flash memory. Examples of program instructions include machine code generated by compilers as well as high-level language code executable by computers using interpreters. The hardware devices may be configured to operate as one or more software modules for performing the operations of the embodiments, and vice versa.

Although embodiments have been described with reference to limited embodiments and drawings, those skilled in the art will appreciate that various modifications and variations can be made based on the above description. For example, the described techniques may be performed in an order different from that described; and/or components of the described systems, structures, devices, and circuits may be combined or coupled in different forms or replaced with other components or equivalents to achieve appropriate results. Therefore, other implementations, other embodiments, and equivalents to the claims are within the scope of the claims set forth below.

What is claimed is:

1. A terminal access control system using graphic acceleration based on HTML5 environment, implemented by a computing device including one or more processors and one or more memories storing instructions executable by the processors, comprising:
an acceleration target determination unit configured to determine, when detecting that a user account attempts to retrieve first information among a plurality of pre-stored pieces of information, whether the first information is first image information that becomes a target of a graphic acceleration process in an HTML5 environment;
a graphic acceleration processing unit, equipped with a graphic processing device, configured to, when the acceleration target determination unit determines that the first information is the first image information, start a graphic acceleration process based on the HTML5 environment for the first image information, analyze a plurality of frames corresponding to an image based on the first image information, and generate processed image information to be transmitted to the user account;
a viewing access control unit configured to, upon completion of the generation of the processed image information by the graphic acceleration processing unit, receive the processed image information from the graphic acceleration processing unit and determine, based on policy information received from a linked policy server, whether the processed image information is viewable and transmittable to the user account; and
an image restoration and output unit configured such that, when the user account is in a logged-in state and when the viewing access control unit determines that the processed image information satisfies a security policy based on the policy information and transmits the processed image information, the image restoration and output unit performs a decryption and restoration process for the received processed image information, and restores and outputs the processed image information—on which the HTML5-based graphic acceleration process has been completed—into image content based on the first image information, wherein the acceleration target determination unit comprises:
an information category checking unit configured to, when access based on a Remote Desktop Protocol (RDP) is detected from the user account and an attempt to retrieve the first information among the pre-stored information is detected, check a category of the first information; and
an acceleration target identifying unit configured to, when the information category checking unit determines that the category of the first information corresponds to a category transmitted and received in the HTML5 environment, identify the first information as the first image information that becomes a target of the graphic acceleration process.

2. The terminal access control system using graphic acceleration based on HTML5 environment of claim 1, wherein the graphic acceleration processing unit comprises:
a change-area analysis unit configured to, when the acceleration target determination unit determines that the first information is the first image information, start a graphic acceleration process based on the HTML5 environment for the first image information, identify each of a plurality of frames constituting an image based on the first image information, and compare a first frame with subsequent frames following the first frame to analyze whether a change area satisfying a preset change condition exists in an area of a second frame compared with an area of the first frame; and
a frame grouping unit configured to, when the change-area analysis unit detects that the second frame includes a change area satisfying the preset change condition compared with the first frame, classify the first frame as a reference frame and extract only the change area from the second frame and group it with the reference frame.

3. The terminal access control system using graphic acceleration based on HTML5 environment of claim 2, wherein the preset change condition is a reference condition for identifying a change area by comparing a later frame with a previous frame among the plurality of frames, and is a condition value for determining whether a difference exists in grid values of a part of the overall area of the later frame compared to the overall grid of the previous frame after dividing both the previous frame and the later frame into equal-sized grids.

4. The terminal access control system using graphic acceleration based on HTML5 environment according to claim 2, wherein the graphic acceleration processing unit further comprises:
a processed-image-information generation unit configured to, upon completion of the function of the frame grouping unit, generate the processed image information based on the reference frame and the partial frames corresponding to the change areas grouped with the reference frame; and
an information encryption-transmission unit configured to, upon completion of the function of the processed-image-information generation unit, encrypt the processed image information based on a preset encryption rule and transmit the processed image information to the viewing access control unit based on a preset protocol.

5. The terminal access control system using graphic acceleration based on HTML5 environment according to claim 4,
wherein the processed image information is script-configurable information, in which, when a later frame among the plurality of frames is compared with a previous frame divided into equal-sized grids, and a difference occurs in grid values of a part of the overall area of the later frame compared to the previous frame, the area corresponding to the changed grid value is extracted as a change area, the previous frame is treated as a reference frame, and partial frames corresponding to the extracted change area are grouped with the reference frame.

6. The terminal access control system using graphic acceleration based on HTML5 environment according to claim 1, wherein the viewing access control unit comprises:
a policy-content checking unit configured to, when the reception of the processed image information from the graphic acceleration processing unit based on a preset protocol is completed, check detailed policy contents based on the policy information received from the linked policy server;
a policy-satisfaction verification unit configured to, upon completion of the function of the policy-content checking unit, check whether attribute information of the processed image information satisfies the detailed policy contents, and determine, based on the verification result, whether the processed image information can be transmitted to the user account; and
a policy-satisfaction information transmission unit configured to, when the attribute information of the processed image information satisfies the detailed policy contents upon completion of the function of the policy-satisfaction verification unit, transmit the processed image information to the image restoration and output unit based on the preset protocol.

7. The terminal access control system using graphic acceleration based on HTML5 environment according to claim 1, wherein the image restoration and output unit comprises:
a key receiving unit configured to, when receiving the processed image information from the viewing access control unit, start a decryption and restoration process for the received processed image information and receive, from the graphic acceleration processing unit, a decryption key based on a preset encryption rule;
a decryption completion unit configured to, upon completion of the reception of the decryption key, apply the decryption key to a pre-stored decryption algorithm to decrypt the encrypted processed image information, and identify a reference frame and partial frames corresponding to change areas grouped with the reference frame based on the processed image information; and
an image content restoration unit configured to, upon completion of the function of the decryption completion unit, sequentially paste the partial frames corresponding to the change areas into the regions where changes occurred in the overall area of the reference frame, thereby restoring the processed image information into the first image information.

8. The terminal access control system using graphic acceleration based on HTML5 environment according to claim 7,
wherein the image restoration and output unit is configured to, upon completion of the function of the image content restoration unit and completion of restoration of the first image information, output, through a display, image content based on the restored first image information, thereby completing the graphic acceleration for the first image information in an HTML5-based Remote Desktop Protocol (RDP) environment.
